(19) United States
(12) Patent Application Publication
(10) Pub. No.: US 2008/0198416 A1
(43) Pub. Date: Aug. 21, 2008

(54) ORDERED STOCK JAM RECOVERY

(75) Inventors: Michael A. WIEGAND, Webster, NY (US); Richard J. EDDY, Webster, NY (US)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/676,788

(22) Filed: Feb. 20, 2007

(51) Int. Cl. H04N 1/00

(52) U.S. Cl. 358/1.18

(57) ABSTRACT

A method of operating a printing system is described, wherein the system includes a marking device, a controller, and a digital front end. The digital front end manages paper jam recovery of a paint job containing ordered stock, including programming the system to produce a pretermined number of prints of ordered stock, selecting an ordered stock comprising successive sets of sheets with each sheet in each of the sets being unique and the unique sheets in each of the sets arranged in a predetermined order, determining the number of different sheets of stock per group from the number of pages in the job and the predetermined number of prints to be made, and utilizing the digital front end upon occurrence of a paper jam to purge the predetermined number of prints of ordered stock.

### BACKGROUND

The present disclosure relates to a method and an apparatus for managing the delivery of print media to a marking device in a printing system and, more particularly to an apparatus for executing a print job after an occurrence of a paper jam.

A desired programming option in printing systems may be choice of stock, the print media on which the prints are made. One desirable stock type is ordered stock, including precut tabs and/or a series of different color sheets. However, when using ordered stock, care must be taken to assure that the correct image is printed on the correct stock throughout the print process. For example, when using precut tabs, one must be sure that the image being printed matches up with the correct tab and that this remains so during the entire printing process. Otherwise, should there be for some reason a mismatch during the printing process, not only will the affected image end up printed on the wrong tab, but the entire sequence of images printed thereafter will be disrupted with the remaining images on the wrong tabs.

In order to manage complex outputs, printing systems require digital front ends (DFE), also known as raster image processors (RIP), to assemble the complete picture of what output is going to look like, separate the images into the appropriate colors, and send the information to the marking device. The role of the DFE is to allow organizations to make the best use of their expensive printing systems. Simple desktop printers do not need management and control systems, because the output is inexpensive. They simply print whatever is sent to them. Color laser printers, production printers, and digital presses are more expensive to operate and have a high cost-per-page.

The digital front end serves as a control point to give the organization control over the print device. With the demand for more sophisticated documents, the capabilities of the DFE have grown to accommodate the complexity of the page layout and leave the production to the printer, shielding it from the page manipulation. To a marking device, an eight-page paper and an eight-page booklet are almost the same. The DFE is responsible for positioning the pages in the booklet on the right sheets of paper and adding the cover the user requests from a previous job. The DFE is responsible for pulling together the necessary images and building data-driven graphics so that the marking device receives a fully composed document. When the marking device tries to handle all of these functions alone, it cannot print close to the maximum rated speed.

Currently, an image output terminal (IOT) is often used to control the paper jam recovery. In particular, the IOT manages the purging of extra ordered stock parts during the jam recovery. For example, where a print job is programmed in which the number of tabs in each print group is not an exact multiple of the number of tab positions being used, the extra or additional tabs must be purged if synchronization between the prints and the tabbed stock is to be maintained. In the example shown in FIG. 7, the number of tabs per output group is 10 while the number of tab positions is 3. The sequence or modulus number is 3, which when divided into 10 shows that 3 sets of prints on tabbed stock together with a single print will result. It can be seen therefore that there will be 2 unused tabbed sheets at the end, which unless purged from the system, will erroneously receive the first two images from the next group of prints. Similarly, should a paper jam occur during the printing cycle, not only must the prints lost be reprinted, but also the tabbed sheet or sheets associated with the replaced prints must be re-ordered to assure that the make up print or prints are printed on the correct X tabbed sheet.

However, for some systems that support ordered stock and incorporate IOTs, the IOT is unable to support sophisticated job recovery, such as ordered stock. In these systems, upon an occurrence of a paper jam, a print job must be terminated and the user must restart the print job from the beginning or make time-consuming manual adjustments to re-order the stock.

### SUMMARY

What is needed is a method and apparatus that allows a digital front end (DFE) to manage the purging of ordered stock during a paper jam recovery.

In embodiments, described is a method of managing a paper jam recovery from a digital front end, including receiving a request for a print job containing ordered stock, wherein when upon execution of the print job a paper jam occurs, the digital front end controls purging a number of sheets representative of the number of sheets in the paper jam.

In further embodiments, described is an apparatus capable of printing onto ordered stock, including a digital front end, a controller, and a marking device, wherein the digital front end manages paper jam recovery.

In still further embodiments, described is a method of operating a printing system, wherein the system includes a marking device, a controller, and a digital front end, wherein the digital front end manages paper jam recovery of a print job containing ordered stock, including programming the system to produce a predetermined number of prints of ordered stock, selecting an ordered stock comprising successive sets of sheets with each sheet in each of the sets being unique and the unique sheets in each of the sets arranged in a predetermined order, determining the number of different sheets of stock per group from the number of the pages in the job and the predetermined number of prints to be made, and utilizing the digital front end upon occurrence of a paper jam to purge the predetermined number of prints of ordered stock.

The methods and apparatus herein thus have utility in reducing the cost and time for recovering from a paper jam in a system that supports ordered stock, insuring that each copy is identical, and that the correct ordered stock is used for each page within a set.

### BRIEF DESCRIPTION OF THE DRAWINGS

FIG. 1 is a perspective view of a printing system for printing ordered stock in accordance with the present disclosure;

FIG. 2 is a block diagram depicting the major elements for the printing system;

FIG. 3 is a flow chart of a method for a paper jam recovery in accordance with the present disclosure:

FIG. 4 is an elevational view of a five tab example of precut tab stock;

FIG. 5 is an elevational view of a three tab example of printed tab stock;

FIG. 6 is an elevational view of an example of ordered print media stock: and

FIG. 7 is an isometric view of an exemplary print job in which the number of tabs in each set is not an exact multiple of the number of tab positions used.

### EMBODIMENTS

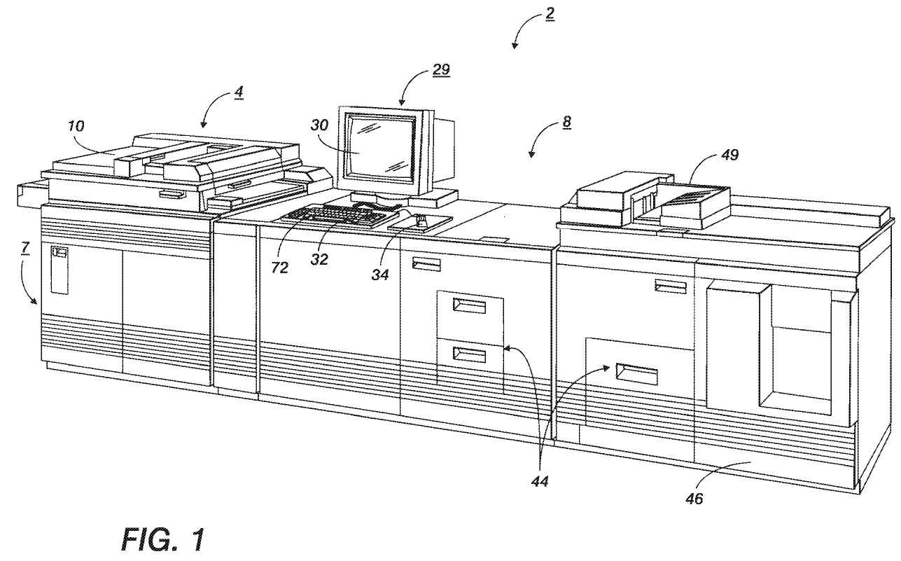

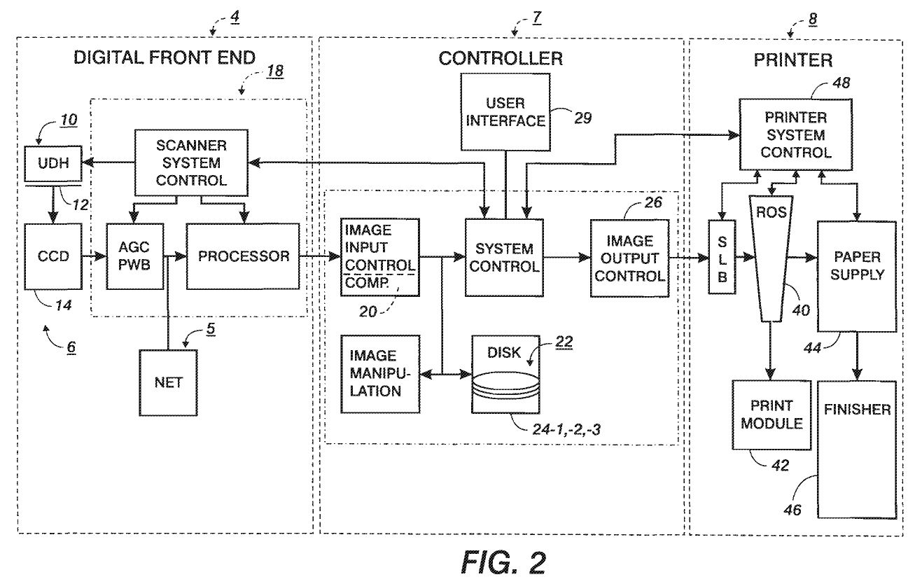

Referring to FIGS. 1 and 2, there is shown an exemplary image printing system 2 of the type adapted to print ordered stock in accordance with the present disclosure. Printing system 2 includes an image input device or digital front end (DFE) 4, controller terminal 7, and a printing device 8. DFE 4 has both remote and on-site image inputs, enabling system 2 to provide network, scan, and print services. Other system combinations may be envisioned, such as a stand alone printing system with an on-site image input (for example, a scanner), controller, and printer; a network printing system with remote input, controller, and printer, etc.

For on-site image input, DFE 4 may have a document scanner 10 for the purpose of automatically and sequentially placing and locating sets of multiple documents on a platen 12 for scanning by one or more linear light sensitive arrays 14. Array 14, which may utilize charge-coupled device (CCD) technology or the like, provides image elemental signals or pixels representative of the image scanned which are input to processor 18 for processing. Alternatively, documents may be located on platen 12 manually for scanning.

Processor 18 converts the analog image signals output by array 14 to digitally represented facsimile signals and processes the signals as required to enable controller terminal 7 to store and handle the image in the form and order required to carry out the job programmed. After processing, the image signals are output to controller terminal 7. A detailed description of a control architecture suitable for use as controller terminal 7 is provided by either U.S. Pat. No. 5,133,048 to Parsons et al or U.S. Pat. No. 5,243,518 to Holt et al., each of which disclosure is incorporated herein by reference.

For off-site image input, DFE 4 may have a network 5 with a suitable communication channel such as a telephone line enabling image data in the form of image signals or pixels from one or more remote sources to be input to processor 18 for processing. In embodiments, where the Page Description Language (PDL) of the incoming imaging data is different than the PDL used by system 2, suitable conversion means (not shown) are provided. In further embodiments, other remote sources of image data such as streaming tape, floppy disk and the like may be envisioned.

The image data from processor 18 is compressed by image compressor/processor 20 and placed in an image file, which is stored in memory 22 pending use. Memory 22 may have a plurality of hard disks, for example 24-1, 24-2, 24-3, for this purpose. For printing, the image data is accessed and output to image output controller 26 where the data is decompressed and readied for printing by printing device 8.

As seen in FIG. 1, a user interface (UI) 29 comprising a combined operator controller/CRT display provides a screen 30, keyboard 32, and mouse 34. UI 29 interfaces the operator with printing system 2, enabling the operator to program print jobs and other instructions, and to obtain system operating information, visual document facsimile display, programming information and icons, diagnostic information and pictorial views and the like.

Printing device 8, as shown in FIG. 2, has a laser type printer with a raster output scanner (ROS) 40, print module 42, paper supply 44, finisher 46, and printer system control 48. ROS 40 uses plural laser beams modulated in accordance with the content of an image signal input by acousto-optic modulator to create latent electrostatic images on a photoreceptor. The latent electrostatic images are developed, transferred and fixed to a print media delivered by paper supply 44 (comprising a print media tray of the type shown in FIG.). The finished prints are delivered to either top tray 49 or to finisher 46 (FIG. 2), which provides certain finishing selections such as a stitching, stapling and the like. Printer system control 48 automatically and precisely controls all the printer functions and operations in accordance with job program instructions received from controller terminal 7.

While a specific printing system is shown and described, the present disclosure may be used with other types of printing systems. For example, printing device 8 may instead use a different printer type such as ink jet, ionographic, thermal, photographic and the like, and furthermore may be incorporated in electronic display systems, such as CRTs, LCDs, LEDs and the like, or else other image scanning/processing/recording systems, or else other signal transmitting/receiving, recording systems and the like as well. Additionally, it should be appreciated that the number of print media or paper trays associated with Paper Supply 44 can be expanded considerably through use of one or more modules.

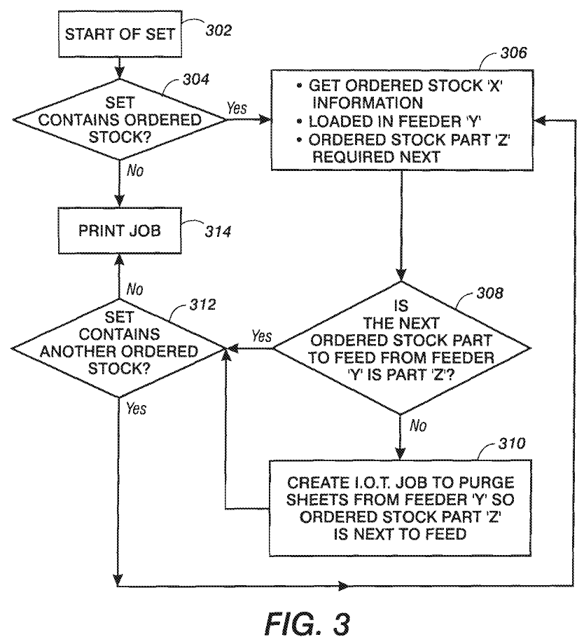

With reference now to FIG. 3, a print job request is received by the DFE 4 at step 302. One of the selections made by a user when requesting a print job is to choose the print stock on which prints will be made. Thus, at step 302, the print job, which includes the selection of print stock, is requested. Stock selections (except in cases where the stock is currently loaded) are loaded into the print media tray 44 (FIG. 1). This is achieved by opening the tray and inserting stock therein.

At step 304, the DFE 4 determines whether or not the print job requested contains ordered stock. If the print job does not contain ordered stock, the DFE 4 passes the request to step 314 at which point the print job is executed. However, when the print job contains ordered stock, as in the case of a “precut tab” for example, additional programming information is necessary in order for the DFE 4 to insure that the images printed are matched with the correct sheet of stock. This additional programming information, referred to herein as the sequence or modulus number, that is, the number of ordered stock sheets in a set, is required to avoid conflicts and inadvertent operator programming errors, to allow the DFE 4 to request a purge of excess sheets, and to enable a print job recovery in the event of a fault such as a paper jam as will be discussed below in greater detail.

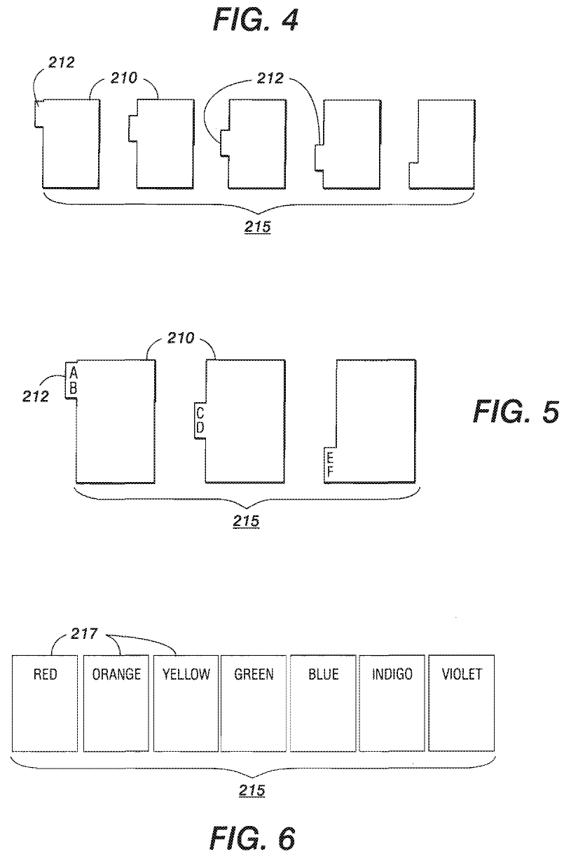

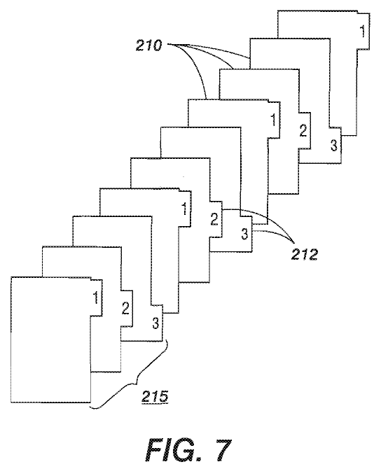

With reference to FIG. 4, a precut tab (that is, tabbed stock) in accordance with the present disclosure will now be illustrated. A precut tab comprises a sheet 210 of print media stock having a tab 212 projecting from one side. As will be understood, tabbed sheets 210 are typically used to facilitate access to specific pages or areas in a bound document or book. Tabs 212 may be clear, that is, without printing as shown in FIG. 4 or may have information or data preprinted thereon as in the preprinted tabs shown in FIG. 5.

The location of tabs 212 along the sides of the tabbed sheet 210 are normally offset from one another to prevent one tab from blocking the view of other tabs. The number of tab offset positions determines the number of tabbed sheets 210 in a series or set 215. In the example shown in FIG. 4, a set 215 composed of 5 tabbed sheets is shown. In the example shown in FIG. 5, a set 215 composed of 3 tabbed sheets 215 of preprinted tabs 212 is shown.

Ordered stock may comprise any set of successively different or unique sheets of print media that forms a repetitive pattern or set 215. In the example shown in FIG. 6, a “rainbow” set of stock is shown where the stock 217 consists of 7 different colors, that is, red orange, yellow, green, blue, indigo, and violet.

At step 306, the DFE 4 obtains the ordered stock information. In embodiments, the information obtained may include the number of ordered stock sets, the number of sheets in each ordered stock set, the type of sheets in each ordered stock set, and the number of feeds needed to complete the print job. Initially, at step 306, the number of ordered stock sets (“OSS”) for the given job is received by the DFE 4 from the program information of the job. Further, at step 308, the DFE 4 determines the number of sheets needed. In embodiments, the number of sheets is determined through use of a conventional stack height sensing arrangement which is capable of ascertaining how many sheets reside in a given tray based on knowledge—inferred or explicit—of the stock thickness or caliper.

step 308, the DFE 4 determines whether an ordered stock set may include multiple feeds in which one stock type is “pulled” multiple times from the print media tray 44. In this event, an exemplary sequence of ordered stock may appear as follows: where “”, “2”, “3”, “4” and “5” represent discrete stock types, respectively. It is understood that unless an accommodation for multiple feeds is made, an accurate assessment of whether enough pseudo or virtual ordered stock is present to produce a given job cannot, in all circumstances, be made. Accordingly, when a tray is to be used for multiple feeds, a normalized value for sheet number is developed.

In embodiments, if it is determined at step 308 that multiple feeds are to be employed, then the number of sheets (obtained in step 308) is normalized with the relationship: (number of sheets)/(feeds per ordered set). In the sequence immediately above, when examining the tray corresponding with the stock type “2, ” a feeds per ordered set number of 2 would be employed.

At step 310, the DFE 4 determines if the next ordered stock to feed from the feeder is available, and if not, the DFE 4 may request printing device 8 to purge sheets so the correct ordered stock is next to feed. In embodiments, a group of prints, including plural sets, is preprogrammed so that each set equals a sequence or modulus number (M), for example, 5. However, one of ordinary skill in the art will appreciate that any number may be preprogrammed as the modulus number. The number of prints to be produced for the group is determined and the number of prints to be produced is divided by M. If a remainder (R) exists as a result of such dividing, then (M-R) sheets are purged after the prints corresponding with the plural sets and the one or more prints corresponding with R have been produced.

At step 312, the DFE 4 obtains any other necessary information through which a determination is made as to whether the tray including ordered stock requires examination. In embodiments, the process can then branch to step 306 for obtaining information on the ordered stock. In further embodiments, the process can use the previous obtained information to execute a print job at step 314. However, for the sequence immediately above, the process would pass by step 308 four times to obtain numbers associated with the respective trays for stock 2, stock 3, stock 4 and stock 5. If the DFE 4 determines that not enough ordered stock is available to complete the requested print job, a notification to the user may be implemented. This notification may include directions on how much ordered stock to load into the tray, and/or directions on how to load the ordered stock into the tray.

Once the DFE 4 determines that there is enough ordered stock to complete the print job, at step 314, the DFE 4 will send the print job request to printing device 8 for execution.

After the DFE 4 sends the printing device 8 the print job information and the printing device 8 is printing the desired print job, a paper jam may occur. As mentioned above, image output terminals may not be able to purge ordered stock upon an occurrence of a paper jam in some printing systems that support ordered stock. In these systems, like the one described herein, without the use of the DFE 4, the jammed paper would need to be cleared, the print job terminated and the print job would need to be restarted from the beginning or manually re-ordered. However, utilizing the information obtained by the DFE 4, this is not necessary.

The DFE 4 maintains knowledge on what sheets within an ordered stock have executed (printed) and what sheets have not. Thus, if a paper jam occurs, and after an occurrence of a paper jam, at step 306 the DFE 4 knows what sheets have printed and what sheets have not, and the DFE 4 also knows the availability of ordered stock within printing device 8. The DFE can use this information to either purge more ordered stock if it is available, or notify the user to load more ordered stock into the tray.

After the DFE 4 obtains the required information for the ordered stock to print after the paper jam, the DFE 4 sends a request to printing device 8 for the print job to be executed. In embodiments, the DFE 4 requests the printing device 8 to purge not only the ordered stock lost during the paper jam, but the entire print job to assure that the paper jam recovery print is printed on the correct tabbed sheets. However, in cases such as this, the sheets that have already been printed may not be reprinted, and only the sheets that were not printed because of the paper jam will be printed. For example, in the event of a paper jam, a purge number representative of the number of sheets to be purged from a paper path, in the event of a jam in the paper path, is determined. In response to a jam in the paper path, sheets are purged from the paper path and the purge number is employed to determine the number of ordered stock sheets, which must be referred for the sake of replacing the purged sheets.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method of managing a paper jam recovery from a digital front end, comprising:
receiving a request for a print job containing ordered stock, wherein upon execution of the print job a paper jam occurs;
utilizing the digital front end to purge a number of sheets of the ordered stock representative of the number of sheets of the ordered in the paper jam; and
restarting the print job at a point where the paper jam occurred to complete the print job.

2. The method of claim 1, wherein the number of pages in the ordered stock in the print Job is preprogrammed to equal a modulus number.

3. The method of claim 2, wherein the modulus number is 5.

4. The method of claim 1, wherein the ordered stock is a tabbed stock.

5. The method of claim 1, wherein the ordered stock is a sequence of different colored sheets.

6. The method of claim 1, further comprising providing ordered stock information to the digital front end.

7. The method of claim 6, wherein the ordered stock information comprises a number of sets of ordered stock, and/or the number of sheets in each set, and,/or the number of feeds needed to complete the print job.

8. An apparatus supporting ordered stock, comprising:
a digital front end;
a controller; and
a marking device;
wherein the digital front end manages paper jam recovery.

9. The ordered stock apparatus of claim 8, further comprising a user interface for programming an ordered stock profile.

10. The ordered stock apparatus of claim 9, wherein the ordered stock profile is programmed remotely of the marking device.

11. The ordered stock apparatus of claim 8, wherein a set of ordered stock is configured so that each page comprises a tab.

12. The ordered stock apparatus of claim 11, wherein the tab of each sheet differs from the position of any other tab within the set of ordered stock.

13. The ordered stock apparatus of claim 8, wherein the marking device includes a media tray containing a plurality of ordered stock.

14. The ordered stock apparatus of claim 8, wherein the digital front end is remote from the marking device.

15. A method of operating a printing system, wherein the system includes a marking device, a controller, and a digital front end, wherein the digital front end manages paper jam recovery of a print job containing ordered stock, comprising:
programming the system to produce a predetermined number of prints of ordered stock;
selecting an ordered stock comprising successive sets of sheets with each sheet in each of the sets being unique and the unique sheets in each of the sets arranged in a predetermined order;
determining the number of different sheets of stock in a set from the number of the pages in the job and the predetermined number of prints to be made;
utilizing the digital front end upon occurrence of a paper jam to purge the predetermined number of prints of ordered stock; and
restarting the print job at a point where the paper jam occurred to complete the print job.

16. The method of claim 15, wherein the ordered stock is tabbed stock.

17. The method of claim 15, wherein the ordered stock is a sequence of different colored sheets.

18. The method of claim 15, wherein the predetermined number of prints of ordered stock is 5.
